(19) United States
(12) Patent Application Publication
(10) Pub. No.: US 2025/0387199 A1
(43) Pub. Date: Dec. 25, 2025

(54) OCCLUSAL BLOCKS FOR DENTAL APPLIANCES AND METHODS FOR MAKING SAME

(71) Applicant: ALIGN TECHNOLOGY, INC., San Jose, CA (US)

(72) Inventors: Jun SATO, San Jose, CA (US); James NISHIMUTA, Durham, NC (US); Srinivas KAZA, Mountain View, CA (US); David TURNER, Durham, NC (US); Trent Nathaniel MORTON, Cary, NC (US); Ravi Rasik PATEL, Raleigh, NC (US)

(21) Appl. No.: 19/243,177

(22) Filed: Jun. 19, 2025

Related U.S. Application Data
(60) Provisional application No. 63/662,847, filed on Jun. 21, 2024.

(51) Int. Cl. A61C 7/08; A61C 9/00

(52) U.S. Cl. CPC A61C 7/08; A61C 9/0006; A61C 9/0053

(57) ABSTRACT

A method of fabricating an orthodontic aligner may include forming a mold for an orthodontic aligner. The mold may include tooth receiving cavities shaped to move teeth of a patient form a first orientation towards a second orientation and a receptacle shaped to receive a base of a mold for an occlusal block. The method may include inserting a mold for an occlusal block into the receptacle, the mold for the occlusal block including a base for insertion into the receptable and a block support structure coupled to the base. The method may also include overmolding a sheet of aligner material over the mold for the orthodontic aligner and the mold for the occlusal block and removing the sheet of aligner material from the mold for the orthodontic aligner while retaining the block support structure in the orthodontic aligner.

### RELATED APPLICATIONS

This application claims the benefit under 35 U.S.C. § 119 (e) of U.S. Provisional Patent Application No. 63/662,847, filed Jun. 21, 2024, and titled “OCCLUSAL BLOCKS FOR DENTAL APPLIANCES,” which is incorporated herein, in its entirety, by this reference.

### BACKGROUND

The present disclosure is generally related to the design and fabrication of occlusal blocks for dental appliances for use in treating malocclusions with oral appliances, such as for mandibular relocation.

Dental treatments may involve procedures for repositioning misaligned teeth and changing bite configurations for improved cosmetic appearance and/or dental function. Repositioning can be accomplished, for example, by applying controlled forces to one or more teeth and/or the jaw over a period of time.

Orthodontic repositioning of teeth may be achieved through the use of orthodontic repositioning appliances. Such appliances may utilize a thin shell of material having resilient properties, referred to as an “aligner,” that generally conforms to a patient's teeth and applies tooth repositioning forces to incrementally reposition the patient's teeth.

Placement of such an appliance over the teeth may provide controlled forces in specific locations to gradually move the teeth into a new configuration. Repetition of this process with successive appliances can move the teeth through a series of intermediate arrangements towards a final arrangement.

In various instances, teeth of a patient's upper jaw and teeth of the patient's lower jaw may contact in an incorrect or suboptimal manner (e.g., crowding, crossbite, deep bite). A proper fit of the occlusal surfaces of the teeth is helpful for proper biting and chewing, as well as for a desirable aesthetic appearance. Otherwise, premature wear of the teeth, undesirable flexion of the teeth, and/or undesirable forces on dental restorations may be experienced by the patient. For instance, a proper fit can be a function of the relative positions of teeth and the mandible and maxilla, either of which may be retruded or protruded relative to the ideal position. The maxilla (e.g., the upper jaw) is a bone that is fixed to the skull. The mandible (e.g., lower jaw) is a bone that is attached to the skull by numerous muscles which guide its movement. The mandible articulates at its posterior upward extremities with the temporal bone to form the jaw joint. The jaw joint is a loosely connected joint that accommodates the variety of movements of the mandible relative to the maxilla during biting and chewing motions. The numerous muscles attaching the mandible to the skull control and power the complex movements involved in biting and chewing. Because the condylar relationship affords some flexibility in the positioning of the jaw, the lower jaw can be intentionally repositioned in accordance with the fit of the teeth, for instance, by using an oral appliance.

Prior approaches to mandibular repositioning can be less than ideal in at least some respects. For example, at least some of the prior devices that user occlusal blocks suffered from significant deformation, including the crushing of the occlusal blocks, during normal wear and under normal occlusal forces. Other attempts, such as by filling cavities forming the occlusal blocks in the aligner with material are difficult to fabricate and handle during fabrication resulting in long fabrication times and excessive handling.

In light of the above, improved mandibular relocation devices that overcome at least some of the above limitations of the prior devices would be helpful.

### SUMMARY

Embodiments of the present disclosure provide improved oral appliances for mandibular relocation with improved engagement that can allow for improved fabrication processes and resilience to plastic deformation and crushing or collapsing under occlusal forces.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIGS. 1A, 1B, and 1C show various block designs for an oral appliance, in accordance with some embodiments;

FIGS. 2A and 2B show aspects of a block design and fabrication method for an oral appliance, in accordance with some embodiments;

FIGS. 3A, 3B, and 3C show aspects of a block design and fabrication method for an oral appliance, in accordance with some embodiments;

FIG. 4 shows various block designs for an oral appliance, in accordance with some embodiments;

FIG. 5 shows a block design for an oral appliance, in accordance with some embodiments;

FIGS. 6A and 6B show various block designs and structures for an oral appliance and fabrication thereof, in accordance with some embodiments;

FIG. 7A shows an experimental appliance mold and blocks an oral appliance and fabrication thereof, in accordance with some embodiments;

FIG. 7B shows an experimental oral appliance with appliance blocks fabricated with the mold and blocks of FIG. 7A, in accordance with some embodiments;

FIG. 8A shows an experimental appliance mold and blocks an oral appliance and fabrication thereof, in accordance with some embodiments;

FIG. 8B shows an experimental oral appliance with appliance blocks fabricated with the mold and blocks of FIG. 8A, in accordance with some embodiments;

FIG. 9 show aspects of a block design and fabrication method for an oral appliance, in accordance with some embodiments;

FIGS. 10A and 10B show aspects of a block design and fabrication method for an oral appliance, in accordance with some embodiments;

FIG. 11 depicts an aligner with an occlusal block, in accordance with some embodiments;

FIG. 12 depicts an orthodontic aligner and patient's dental arch, in accordance with some embodiments;

FIG. 13 depicts a system of orthodontic aligners, in accordance with some embodiments;

FIG. 14 shows a method of orthodontic treatment, in accordance with some embodiments;

FIG. 15 shows a method of treatment planning, in accordance with some embodiments;

FIG. 16 shows a system for use in dental treatment, in accordance with some embodiments; and

FIG. 17 shows an intraoral scanning system, in accordance with some embodiments.

### DETAILED DESCRIPTION

The following detailed description provides a better understanding of the features and advantages of the present disclosure in accordance with the embodiments disclosed herein. Although the detailed description includes many specific embodiments, these are provided by way of example only and should not be construed as limiting the scope of the inventions disclosed herein.

The methods, apparatus, oral appliances and blocks disclosed herein are well suited for combination with prior devices such as aligners to reposition teeth, for example the Invisalign™ system commercially available from Align Technology, Inc. For example, a plurality of appliances can be sequentially applied to a patient's dentition for tooth movement at different incremental sequential stages of treatment and for mandibular relocation either in combination with tooth movement stages or separate stages for mandibular relocation. Also, the presently disclosed occlusal blocks are well suited for incorporation into prior devices for mandibular relocation to provide improved fabrication processes and durability.

The presently disclosed methods and apparatus are well suited for combination with prior approaches to manufacturing aligners, such as with direct fabrication and overmolding such as thermoforming. For example, the presently disclosed blocks can be placed on a positive mold which may include aspects of the patient's dentition, and one or more polymeric layers of material thermoformed over the blocks or to form cavities in which to receive the blocks. Also, the blocks are well suited for additive manufacturing such as 3D printing. The plurality of blocks as described herein can be placed on a computer model of the patient's mouth and modified to facilitate design of mandibular relocation appliances, such as during the treatment planning process. For example, in a process for digitally planning an orthodontic treatment and/or design or fabrication of an appliance, as described herein.

The present disclosure describes appliances and structures for mandibular relocation, including treating class II malocclusions, class III malocclusions, sleep apnea correction, and temporomandibular disorders, such as those affecting the temporomandibular joint. An oral appliance for insertion into the mouth of a patient may comprise a plurality of blocks having engagement structures for generating mandibular relocation forces and positioning. The appliance may include teeth receiving cavities for fitting over the teeth of a patient, such as with an orthodontic aligner. A plurality of occlusal blocks is provided with the appliance and promotes mandibular relocation, such as by promoting mandibular advancement, retraction, lateral correction, or a combination.

The occlusal blocks cooperate to align the mandible with the maxilla according to a treatment profile as part of a treatment plan. For example, a first occlusal block can be associated with an appliance coupled to upper teeth of a patient, and a second occlusal block can be associated with an appliance coupled to lower teeth of a patient. The first and second occlusal blocks may be located to engaged with one another at engagement surfaces to maintain the mandible in a desired position, such as by interfering with retraction, advancement, or lateral movement of the mandible once the mandible is properly located.

The occlusal blocks may have engagement surfaces on which a first occlusal block on a first appliance engages a second occlusal block on a second appliance. The engagement between engagement surfaces of upper and lower appliances cause the application of forces on the mandible to correct for class II malocclusions, class III malocclusions, or other types of misalignment of the mandible or temporomandibular disorders, such as those affecting the temporomandibular joint.

The blocks are well suited for easy design and manufacturing of blocks having varying geometries, including various sizes and shapes, to account for changes in the patient's dentition and jaw during treatment.

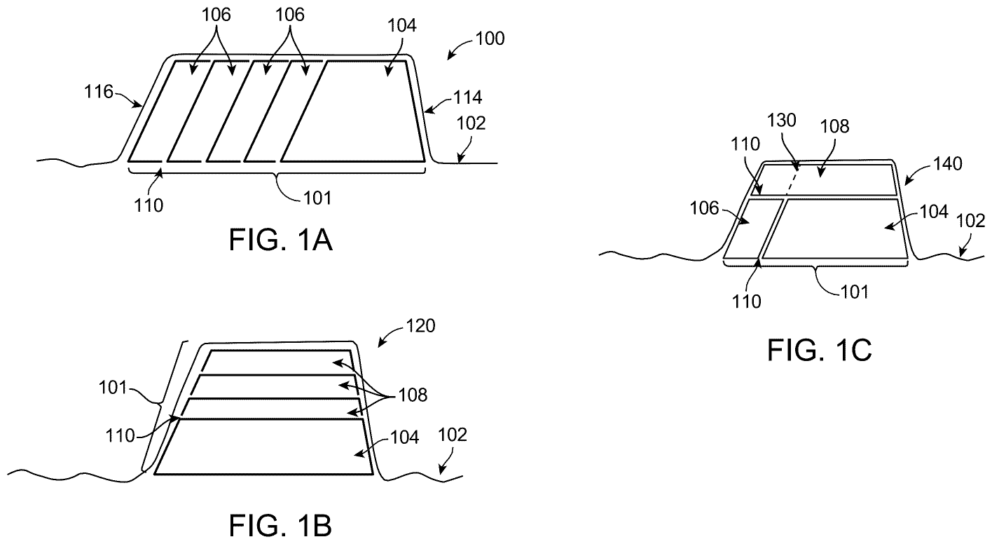

FIG. 1A shows an occlusal block 100 formed with an appliance shell 102 and a support block 101 within a block receiving cavity 114 of the appliance shell 102. Although only a portion of the appliance shell 102 is depicted, the appliance shell 102 can be configured to fit over an entire dental arch. In some embodiments, the appliance shell 102 may be designed to fit over some or all of the teeth in the upper or lower jaw. For example, the appliance shell 102 may be formed with a plurality of teeth receiving cavities that allow the appliance shell 102 to securely fit onto the dental arch. The appliance shell 102 and the occlusal block 100 may form an orthodontic appliance, as discussed herein. The appliance shell 102 may include an engagement surface 116 that engages with an engagement surface of a corresponding engagement surface of an occlusal block on an appliance shell of an opposing jaw, when worn by a patient.

One or more occlusal blocks 100 may be place at any suitable location of an oral appliance, but according to some embodiments, corresponding pairs of occlusal blocks 100 are placed on an appliance associated with the upper jaw of a patient and on an appliance associated with the lower jaw of a patient. In some embodiments, the corresponding pairs of occlusal blocks 100 reposition the lower jaw relative to the upper jaw. For example, the lower jaw may be repositioned anteriorly (e.g., correcting for retrognathism), posteriorly (e.g., correcting for prognathism), or laterally with respect to the upper jaw. Accordingly, the corresponding pairs of engagement structures can be used with an oral appliance to address class 1, class 2, or class 3 malocclusions in a patient.

The oral appliance may be made of any suitable material as will be appreciated by one of ordinary skill in the art. In some embodiments, the appliance shell 102 may be formed by overmolding or direct fabrication, for example. As an example, one or more engagement structures 110 may formed by placing support block 101 on a positive orthodontic appliance mold, and an overmold material, which may be any of a number of suitable polymers, is molded over the support block 101 and the positive mold. The result is an oral appliance that comprises a plurality of teeth receiving cavities and occlusal block 100 with the support structure 101 with the occlusal blocks as described herein embedded within cavity 114 of the shell 102, for example.

As shown in FIG. 1A, and occlusal block 100 may include a support structure 101 which may be a modular support structure. The modular support structure includes a base module 104 and one or more additional structures 106 that combine with the base module 104 to form the support structure 101 of the occlusal block 100. The occlusal block 100 includes a modular support structure that includes additional structures 106 of different dimensions, such as different lengths, withs, depths, etc., that allows the support structure to have different lengths depending on the number of additional structures 106 that are attached to the base module 104. The additional structures 106 may be added to the base module 104 of the support structure 101.

Although the additional structures 106, which may also be referred to as stacking elements, are depicted as all being of a uniform size, in some embodiments the additional structures may have different sizes. For example, a kit may be provided with a support structure 104 having a first additional block having a first length, a second additional block having a length twice as long as the first length, third additional block having a length three times as long as the first length, and fourth additional as long as the first length. In this way, various lengths of the occlusal block 101 may be formed by using different combinations of blocks, for example 6 units of additional length be added by using the block having twice the first length and a block having four times the first length, without having to use six additional blocks.

In some embodiments, the blocks may include interlocking features 110. The interlocking features may be any of the interlocking features described herein, such as, for example, tabs and slots. With tabs and slots, a tab or extension on one part fits into a slot or aperture on another part. This arrangement can prevent movement in one or more directions and hold the additional structures 106 to each other and/or the base module 104. In some embodiments, the tabs may be located on a first side of an additional module and the slots may be located on a second side of the additional module such that when stacking or coupling the additional modules together the tabs of one module may be inserted into the slots of an adjacent module and/or the base module. Tabs and slots are easy to assemble and provide for alignment among the components of the occlusal block 101.

In some embodiments, dovetail joints may be used. With a dovetail joint projections may have a trapezoidal cross-section which may couple to corresponding recesses having a similar trapezoidal cross-section. The projections and recesses may extend linearly such that the projections may slide into the recesses. This arrangement may provide improved interlocking and may aid in resisting the polar part of the components and hold the additional structures 106 to each other and/or the base module 104. In some embodiments, the projections may be located on a first side of an additional module and the recess may be located on a second side of the additional module such that when stacking or coupling the additional modules together the projections of one module may be inserted into the recess of an adjacent module and/or the base module.

In some embodiments, a snap fit may be used to couple additional structures and the base structures. Snap fits may include cantilever snap fits, annular snap fits, or other types of snap fits. Cantilever snap fits may include a long, thin beam that deflects to allow entry or removal. The beam has a hook or bead at the end that catches onto a ledge or into a recess. The beam and the ledge or recess may be located on one or both of the additional structures 106 and the modules 104. For example, a beam that may be located on a first side of an additional structure, and a recess or ledge may be located on a second side of the additional structure such as multiple additional structures may be coupled together. The base module may also include one or both of a beam and the ledge or recess.

Annular snap fit may include a circular or partially circular beam or extension that extends into a corresponding first groove or recess and having a second groove around the perimeter of the first groove or recess. The circular beam or extension may be located on a first end of an additional structure and a corresponding groove or recess may be located on a second end of an additional structure and/or a base module 104.

During fabrication, the base module 104 and additional structure or structures 106 may be coupled together to form the support structure 101 before being inserted into the cavity of the aligner. After insertion, the base module 104 and/or additional structures 106 may be coupled to the aligner using one or more methods described herein, such as using adhesive, laser welding, or other welding process, or another method by which the support structure 101 is coupled, such as permanently coupled, to the aligner. Permanently coupled may include coupling such that removal or separation of the parts results in damage to one or more of the constituent parts, such as fracturing, plastic deformation, or other damage. In some embodiments, for example, damage may be damage that causes the Aligner to not function as designed or results in the aligner or the support structure 101 to be remanufactured.

As shown in FIG. 1B, and occlusal block 120 may include a support structure 101 which may be a modular support structure. The modular support structure includes a base module 104 and one or more additional structures 108 that combine with the base module 104 to form the support structure 101 of the occlusal block 120. The occlusal block 120 includes a modular support structure that allows the support structure for have different heights depending on the number of additional structures 108 that are attached to the base module 104. The additional structures 108 may be added to the base module 104 of the support structure 101.

Although the additional structures 108, which may also be referred to as stacking elements, are depicted as all being of a uniform size, in some embodiments the additional structures may have different sizes, such as height, thickness, width, depth, etc. For example, a kit may be provided with a support structure 104 a first additional block having a first height, a second additional block having a height twice as long as the first height, third additional block having a height three times as long as the first height, and fourth additional block having fourth the first height. In this way, the height of the occlusal block 101 may be formed by using different combinations of blocks, for example 6 units of additional height be added by using a block having twice the first height and a block having four times the first height, without having to use six additional blocks. Additional structures 108 may have differences (twice, three times, and/or four times) in other dimensions, such as width, length, depth, etc.

In some embodiments, the blocks may include interlocking features 110. The interlocking features may be any of the interlocking features described herein, such as, for example, tabs and slots, etc., as discussed herein.

During fabrication, the base module 104 and additional structure or structures 108 may be coupled together to form the support structure 101 before being inserted into a cavity of the aligner shaped to receive the support structure or having an aligner formed over the support structure. After insertion, the base module 104 and/or additional structures 108 may be coupled to the aligner using one or more methods described herein, such as using adhesive, laser welding, or other welding process, or another method by which the support structure 101 is coupled such as permanently coupled to the aligner. Permanently coupled may include coupling such that removal or separation of the part result in damage to one or more of the constituent parts, such as fracturing, plastic deformation, or other damage, that would cause the aligner or the support structure 101 to be remanufactured.

As shown in FIG. 1C, and occlusal block 140 may include a support structure 101 which may be a modular support structure. The modular support structure includes a base module 104 and one or more additional structures 106, 108 that combine with the base module 104 to form the support structure 101 of the occlusal block 140. The occlusal block 140 includes a modular support structure that allows the support structure for have different heights and lengths depending on the number of additional structures 106, 108 that are attached to the base module 104. The additional structures 106, 108 may be added to the base module 104 of the support structure 101.

The additional structures 106, 108 which may also be referred to as stacking elements, may have a uniform respective length or height, in some embodiments the additional structures may have different sizes. For example, a kit may be provided with a support structure 104 with additional structures 106, 108, as discussed herein, to adjust the length and/or height.

In some embodiments, the blocks may include interlocking features 110. The interlocking features may be any of the interlocking features described herein, such as, for example, tabs and slots, etc., as discussed herein.

During fabrication, the base module 104 and additional structure or structures 106, 108 may be coupled together to form the support structure 101 before being inserted into a cavity of the aligner shaped to receive the support structure or having an aligner formed over the support structure. After insertion, the base module 104 and/or additional structures 106, 108 may be coupled to the aligner using one or more methods described herein, such as using adhesive, laser welding, or other welding process, or another method by which the support structure 101 is coupled such as permanently coupled to the aligner. Permanently coupled may include coupling such that removal or separation of the part result in damage to one or more of the constituent parts, such as fracturing, plastic deformation, or other damage, that would cause the aligner or the support structure 101 to be remanufactured.

In some embodiments, such as those depicted in FIGS. 1A, 1B, and 1C, the base 104 in the additional structures 106, 108 may come pre-fabricated or assembled such that the base has a plurality of additional structures 106, 108 attached thereto. Then, in order to form a support structure 101 of the desired size, the additional structures 106, 108 may be removed or separated from the base and/or the other additional structures. In some embodiments the base 104 and additional structures 106, 108 may be a single part and may have one or more separation features 130, which may be scores or stress concentrations or other structures to facilitate separation of an additional structure 106, 108 from a base structure 104 and/or other additional structures 106, 108. In some embodiments, the separation features 130 may be frangible structures between respective additional structures and/or the base which may allow a dentist or other dental professional to break the frangible structures to remove the additional structures 106, 108 from the supporting structure 101.

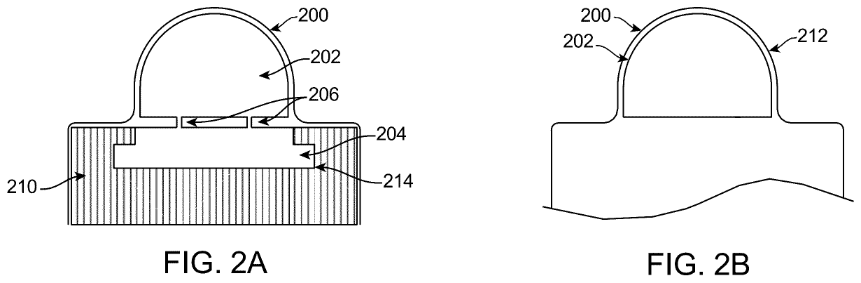

FIGS. 2A and 2B depict aspects of an over molding process and system for fabricating an aligner and associated reinforcing structures of occlusal and other blocks. Over molding with blocks attached to aligner molds has proven to be technically challenging due to difficulty in retaining the blocks on the mold during handling (the molds may travel on conveyors or via other means) and thermoforming manufacturing processes while not being too retentive to cause mold breakage when the aligner is removed from the mold.

FIG. 2A depicts a mold 210 which may be a directly fabricated mold for forming an aligner 200 including one or more occlusal blocks 201. In some embodiments the mold 210 may be fabricated using, for example an SLA fabrication process. The mold 210 may be a negative mold used in a thermoforming process to form an orthodontic aligner. The mold may include structures for forming tooth receiving cavities to move teeth from a first position towards a second position. The mold may also include other structures for forming features of an orthodontic aligner such as, bite ramps, attachment receiving cavities, and other aligner structures. In the embodiment shown in FIGS. 2A and 2B, a reinforcement structure 202 is formed as part of the mold and is retained within the aligner 200 after the molding process is complete.

The mold 210 may include a receptacle 214 for receiving the molded reinforcement 202 for the occlusal block 212. The receptacle 214 may include a cavity for receiving a base 204 of the injection molded reinforcement 202. In some embodiments, the receptacle 214 may be a platform that receives the base 204 therein. The base 204 may be adhered to the platform of the receptacle. In some embodiments, the receptacle 214 may engage with the base 204. For example, the receptacle may extend over the top of the base, such as at least a portion of the outer perimeter of the base, in order to prevent removal of the base from the receptacle.

The reinforcement structure 202 may be coupled to the base 204 via one or more connections 206. The reinforcement structure 202, the base 204, and the one or more connections 206 may be integrally formed as a single structure. For example, in some embodiments the reinforcement structure 202, the base 204, and the one or more connections 206 may be a single injection molded structure.

To fabricate an aligner 200 having one or more blocks 212, the mold 210 and the reinforcement structure coupled to the base 204 are formed. The base 204 is then coupled to the mold 210 via the base 204 to form the finalized aligner mold. The sheet of aligner material, which may be a thermoplastic material, may then be thermoformed over the finalized mold. After the aligner material has set, for example after the thermoplastic material has cooled such as below its glass transition temperature, the aligner 200 may be removed from the mold. During the removal process, the breakaway connections 206 may be broken to separate the reinforcement 202, which may be retained within the aligner 200, from the rest of the finalized mold. In some embodiments, the reinforcement 202 may be further coupled to the aligner 212 such as through welding or other processes described herein before or after separation of the aligner from the mold. The finalized aligner with the retained reinforcement is depicted in FIG. 2B.

The breakaway connections 206 may be configured to break during removal of the aligner and the reinforcement 202 from the finalized mold. In some embodiments, the breakaway connections have a cross-sectional area such that they retain and support the reinforcement 202 during the fabrication process, including transportation, conveyance, and thermoforming process, but break during the aligner removal process so as to allow the reinforcement 202 to be retained within the occlusal block structure. In some embodiments, the couplings may be frangible pillars that extend from the base to the frangible pillars and may be designed to break under a particular stress condition such as the removal of the aligner. In some embodiments, the breakaway connections may include stress concentrations such as scoring or other weakened sections in order to allow the connections to break during the aligner removal process.

Although depicted as being separate materials and being fabricated separately, the reinforcement structure 202 may be fabricated as a unitary part with the mold 210. For example, the reinforcement 212 and breakaway connections 206 may be integrally formed as a single part with the rest of the mold 212. In such an embodiment, the base 204 and recess 214 platform discussed herein may be omitted.

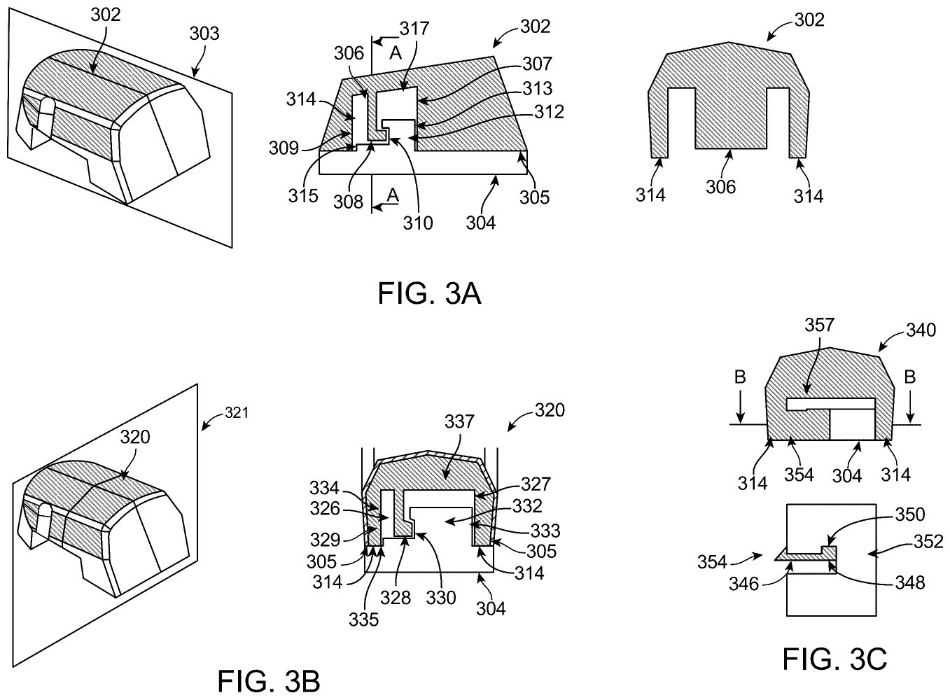

FIGS. 3A, 3B, and 3C show embodiments of block support structures that may be releasably coupled to a mold for use in fabricating an aligner. The block support structures may be released from the mold after fabrication and retained within the aligner.

FIG. 3A depicts a block support structure 302 on an aligner mold 304. The rest of the aligner mold, such as the portions showing the molds for the teeth receiving cavities and other structures, is omitted for clarity. The left most portion of FIG. 3A depicts the support 302 and the cut plane 303 for the cross section depicted in the center depiction of FIG. 3A. The right most image of FIG. 3A depicts a cross section for the cut plane labeled A-A in the center depiction.

FIG. 3A depicts a block support structure 302 coupled to an aligner mold 304 via a two-part coupling. The two-part coupling includes a flexible portion 314 and a rigid portion 312. The flexible portion may include a flexible extension 306 that has an engagement portion 308, such as a hook or bead, that engages with a respective engagement portion 310 of the rigid portion 312. The rigid portion may include an extension that extends upward, such as in an occlusal direction, from a base or platform 305 of the mold. The platform 305 may be shaped to receive the block support structure 302 thereon. In some embodiments, the platform 305 may have a shape that corresponds to the outline for outer perimeter of the lower surface of the block support structure 302.

The rigid portion 312 may include an engagement portion 310, which may be a receptacle, that engages with the engagement portion 308 of the flexible portion 314. In some embodiments, the engagement portion 308 and the engagement portion 310 may have complementary shapes such that the outer surface of the engagement portion 308 may match a shape of the outer surface of the engagement portion 310.

While the rigid portion is depicted as extending from or being part of the mold and the flexible portion is depicted as extending from or part of block support structure 302, in some embodiments, the locations may be switched. For example, the rigid portion may extend from the block support structure 302 with the flexible portion extending from the mold 304.

In some embodiments, the flexible portion 314 extends into a cavity 317 formed within the underside or tooth facing portion of the occlusal block 302. The cavity may have one or more locating features that may interact with corresponding locating features on the mold 304. For example, the cavity 317 may include a sidewall 307 that may be configured to come in contact with a sidewall 313 of the extension 312. The cavity 317 may also include a sidewall 309 that may be configured to come into contact with a sidewall 315 of the extension 312. The respective sidewalls may be displaced from each other in a mesial-distal orientation such that when the block support structure 302 is placed on the mold 304, the respective sidewalls interact in order to align and constrain the movement of the occlusal block upon engagement with the engagement structure. Although not shown in FIG. 3A, additional locating features may be formed along the buccal-lingual direction in order to locate and constrain the movement of the block support structure 302 in the buccal lingual axis. For example, the block support structures may include a first side wall or other locating future on a buccal side of the block support structure 302 and a second side wall or other locating future on a lingual side of block support structure 302. The mold 304 may include a corresponding sidewall or other locating feature on a buccal side of the mold that interacts with the buccal sidewall or other locating future on the block support structure 302. Similarly, the mold may include a corresponding sidewall or other locating feature on a lingual side of the mold that interacts with a lingual side wall or other locating feature on the block support structure 302.

The right portion of FIG. 3A depicts the support structure 302 as viewed in a mesial-distal direction of the A-A cross section. The cross section depicts the buccal and lingual support structures 314. The support structures 314 rest on the mold 304 and in some embodiments, may rest of the platform 305 of the mold 304. The support structures may include sides or lateral or buccal and lingual sidewalls of the block support structure 302. The support structures may contact the platform 305 and provide support to the block support structure 302 during the overmolding process, such as when a sheet of aligner material is thermoformed over the block support structure 302 and the mold. The overmolding process imparts forces on the block support structure 302. Without the support structures 314, the block may deform, which may cause the resulting occlusal blocks to have a shape different that what was planned. Such deformed blocks may not function properly and result in unpredictable or undesirable treatment outcomes. Additionally, the deformation of the block support structure 302 may cause disengagement of block support structure 302 from the mold, causing movement of the block support structure 302 and corresponding undesirable changes in the shape of the final orthodontic device. In some cases, the deformation of the block may result in excessive engagement forces between the block support structure 302 and the mold 304. Such excessive engagement forces may result in the block support structure 302 being strongly retained on the mold 304. This excessive retention may result in damage to the orthodontic appliance during its removal from the mold.

FIG. 3B depicts a block support structure 320 on an aligner mold 304. The rest of the aligner mold, such as the portions showing the molds for the teeth receiving cavities and other structures, is omitted for clarity. The left portion of FIG. 3B depicts the support 340 and the cut plane 321 for the cross section depicted in the right depiction of FIG. 3B.

FIG. 3B depicts a block support structure 320 coupled to an aligner mold 304 via a two-part coupling. The two-part coupling includes a flexible portion 334 and a rigid portion 332. The flexible portion 334 may include a flexible extension 326 that has an engagement portion 328, such as a hook or bead, that engages with a respective engagement portion 330 of the rigid portion 332. The rigid portion may include an extension that extends upward, such as in an occlusal direction, from a base or platform 305 of the mold. The platform 305 may be shaped to receive the block support structure 320 thereon. In some embodiments, the platform 305 may have a shape that corresponds to the outline for outer perimeter of the lower surface of the block support structure 320.

The rigid portion 332 may include an engagement portion 330, which may be a receptacle, that engages with the engagement portion 328 of the flexible portion 334. In some embodiments, the engagement portion 328 and the engagement portion 330 may have complementary shapes such that the outer surface of the engagement portion 328 may match a shape of the outer surface of the engagement portion 330.

While the rigid portion is depicted as extending from or being part of the mold and the flexible portion is depicted as extending from or the part of block support structure. In some embodiments, the locations may be switched. For example the rigid portion may extend in an occlusal direction from the block support structure 320 with the flexible portion extending in a gingival direction from the mold 304.

In some embodiments, the flexible portion 334 extends into a cavity 337 formed within the underside or tooth facing portion of the occlusal block 320. The cavity may have one or more locating features that may interact with corresponding locating features on the mold 304. The cavity 337 includes a sidewall 307 that may be configured to come in contact with a sidewall 313 of the extension 312. The cavity 337 may also include a sidewall 329 that may be configured to come into contact with a sidewall 335 of the extension 332. The respective sidewalls may be displaced from each other in a buccal-lingual orientation such that when the block support structure 320 is placed on the mold 304, the respective sidewalls interact in order to align and constrain the movement of the occlusal block upon engagement with the engagement structure. Although not shown in FIG. 3B, additional locating features may be formed along the mesial-distal direction in order to locate and constrain the movement of the block support structure 320 in the mesial-distal axis. For example, the block support structures may include a first side wall or other locating future on a distal end of the block support structure 320 and a second side wall or other locating future on a mesial end of block support structure 320. The mold 304 may include a corresponding sidewall or other locating feature on a distal end of the mold platform that interacts with the distal sidewall or other locating future on the block support structure 320. Similarly, the mold may include a corresponding sidewall or other locating feature on a distal side of the mold platform that interacts with a distal side wall or other locating feature on the block support structure 320.

The right portion of FIG. 3B depicts the block support structure 320 as viewed in a mesial-distal direction of the cut plane of the left image of FIG. 3B. The cross section depicts the buccal and lingual support structures 314. The support structures 314 rest on the mold 304 and in some embodiments, rest on the platform 305 of the mold 304. The support structures may include sides or lateral or buccal and lingual sidewalls of the block support structure 320. The support structures may contact the platform 305 and provide support to the block support structure 320 during the overmolding process, such as when a sheet of aligner material is thermoformed over the block support structure 320 and the mold. The overmolding process imparts forces on the block support structure 320. Without the support structures 314, the block may deform, which may cause the resulting occlusal blocks to have a shape different that what was planned. Such deformed blocks may not function properly and result in unpredictable or undesirable treatment outcomes. Additionally, the deformation of the block support structure 320 may cause disengagement of block support structure 320 from the mold, causing movement of the block support structure 320 and corresponding undesirable changes in the shape of the final orthodontic device. In some cases, the deformation of the block may result in excessive engagement forces between the block support structure 320 and the mold 304. Such excessive engagement forces may result in the block support structure 320 being strongly retained on the mold 304. This excessive retention may result in damage to the orthodontic appliance during its removal from the mold.

FIG. 3C depicts a block support structure 340 on an aligner mold 304. The rest of the aligner mold, such as the portions showing the molds for the teeth receiving cavities and other structures, is omitted for clarity. The lower portion of FIG. 3C depicts the support 340 about the cross-section line B-B.

FIG. 3C depicts a block support structure 340 coupled to an aligner mold 304 via a two-part coupling. The two-part coupling includes a flexible portion 354 and a rigid portion 352. The flexible portion 354 may include a flexible extension 346 that has an engagement portion 348, such as a hook or bead, that engages with a respective engagement portion 350 of the rigid portion 352. The rigid portion may include an extension that extends upward, such as in an occlusal direction, from a base or platform 305 of the mold. The platform 305 may be shaped to receive the block support structure 340 thereon. In some embodiments, the platform 305 may have a shape that corresponds to the outline for outer perimeter of the lower surface of the block support structure 340.

The rigid portion 352 may include an engagement portion 350, which may be a receptacle, that engages with the engagement portion 348 of the flexible portion 354. In some embodiments, the engagement portion 348 and the engagement portion 350 may have complementary shapes such that the outer surface of the engagement portion 348 may match a shape of the outer surface of the engagement portion 350.

While the rigid portion is depicted as extending from or being part of the mold and the flexible portion is depicted as extending from or part of the block support structure. In some embodiments, the locations may be switched. For example the rigid portion may extend from the block support structure 340 with the flexible portion extending from the mold 304.

In some embodiments, the flexible portion 354 extends into a cavity 357 formed within the underside or tooth facing portion of the occlusal block 340. While the flexible portions depicted in FIGS. 3A and 3B extend from a top or occlusal surface of the cavity, the extension of FIG. 3C extends from a sidewall, which may be a mesial, distal, buccal, or lingual sidewall. The cavity may have one or more locating features that may interact with corresponding locating features on the mold 304. The cavity 357 includes a sidewall that may be configured to come in contact with a sidewall of the extension 352 of the rigid portion. The cavity 357 may also include an opposing sidewall that may be on an opposite side of the cavity that may be configured to come into contact with a corresponding sidewall of the extension 352. The respective sidewalls may be displaced from each other in a buccal-lingual orientation such that when the block support structure 340 is placed on the mold 304, the respective sidewalls interact in order to align and constrain the movement of the occlusal block upon engagement with the engagement structure. Locating features may be formed along the mesial-distal or the buccal-lingual direction in order to locate and constrain the movement of the block support structure 340 in the mesial-distal and/or buccal-lingual axis, respectively.

The block support structure 340 may include buccal and lingual support structures 314. The support structures 314 rest on the mold 304 and in some embodiments, rest of the platform 305 of the mold 304. The support structures may include sides or lateral or buccal and lingual sidewalls of the block support structure 340. The support structures may contact the platform 305 and provide support to the block support structure 340 during the overmolding process, such as when a sheet of aligner material is thermoformed over the block support structure 340 and the mold. The overmolding process imparts forces on the block support structure 340. Without the support structures 314, the block may deform, which may cause the resulting occlusal blocks to have a shape different that what was planned. Such deformed blocks may not function properly and result in unpredictable or undesirable treatment outcomes. Additionally, the deformation of the block support structure 340 may cause disengagement of block support structure 340 from the mold, causing movement of the block support structure 340 and corresponding undesirable changes in the shape of the final orthodontic device. In some cases, the deformation of the block may result in excessive engagement forces between the block support structure 340 and the mold 304. Such excessive engagement forces may result in the block support structure 340 being strongly retained on the mold 304. This excessive retention may result in damage to the orthodontic appliance during its removal from the mold.

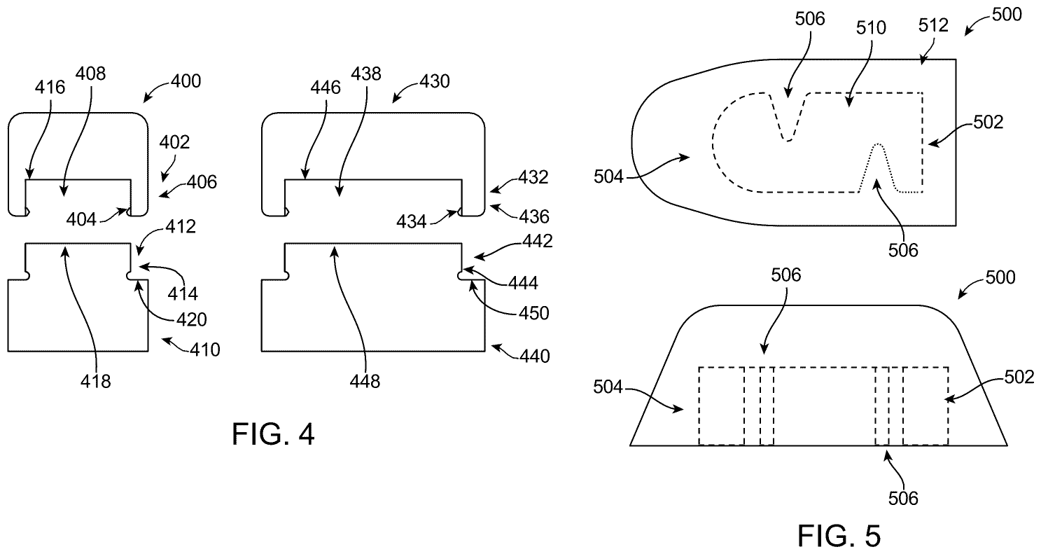

FIG. 4 depicts block support structures 400 and 430 on respective aligner molds 410, 430. The rest of the aligner mold, such as the portions showing the molds for the teeth receiving cavities and other structures, is omitted for clarity.

Block 400 is depicted from a mesial or distal view and depicts a block support structure 400 that is configured to be coupled to an aligner mold 410 via a coupling. The coupling may be a two-part coupling includes a block portion 402 and a mold portion 412. The block portion 402 may include an extension 406 that extends along the buccal side of the block. A similar extension is shown extending from the lingual side of the block 402. The extensions 406 include an engagement portion 404, such as a hook or bead, that engages with a respective engagement portion 414 of the mold portion 412. The mold portion may include an extension that extends upward, such as in an occlusal direction, from a base or platform of the mold. The platform 420 may be shaped to receive the block support structure 400 thereon. In some embodiments, the platform 420 may have a shape that corresponds to the outline for outer perimeter of the lower surface of the block support structure 400. In some embodiments, the buccal extension 406 may comprise a plurality of extension, each having a respective engagement portion 404. In some embodiments, a buccal side extension may comprise a single extension that extends along the buccal side of the block 400 from the distal end to the mesial end of the block. A lingual extension may be similarly configured on a lingual side of the block 400.

The mold portion 412 may include an engagement portion 414, which may be a receptacle, that engages with the engagement portion 404 of the block portion 402. In some embodiments, the engagement portion 414 and the engagement portion 404 may have complementary shapes such that the outer surface of the engagement portion 404 may match a shape of the outer surface of the engagement portion 414.

While the mold portion is depicted as being within the block portion, such that the extensions 406 are on the outer perimeter of the mold portion 412, in some embodiments, the mold portion may include extensions that are on the outer perimeter of the block portion.

In some embodiments, the mold portion 412 extends into a cavity 408 formed within the underside or tooth facing portion of the occlusal block 400 when the block 400 is mounted to the mold 410. In some embodiments, the block may include an extension that extends into a cavity of the mold portion 410, such that the respective engagement structures are switched as compared to what is shown in FIG. 4. The cavity may have one or more locating features that may interact with corresponding locating features on the mold. The cavity includes a sidewall that may be configured to come in contact with a sidewall of the extension of the mold portion. The cavity may also include an opposing sidewall that may be on an opposite side of the cavity that may be configured to come into contact with a corresponding sidewall of the extension. The respective sidewalls may be displaced from each other in a buccal-lingual orientation such that when the block support structure is placed on the mold, the respective sidewalls interact in order to align and constrain the movement of the occlusal block upon engagement with the engagement structure. Locating features may be formed along the mesial-distal or the buccal-lingual direction in order to locate and constrain the movement of the block support structure in the mesial-distal and/or buccal-lingual axis, respectively.

When coupled together, the upper surface 416 of the cavity 408 may be configured to contact the upper surface 418 of the extension of the mold 410. The surfaces may contact each other to provide support to the block 400 during the overmolding process, such as when a sheet of aligner material is thermoformed over the block 400 and the mold. The overmolding process imparts forces on the block 400. Without the contact between the respective surfaces, the block may deform, which may cause the resulting occlusal blocks to have a shape different than what was planned. Such deformed blocks may not function properly and result in unpredictable or undesirable treatment outcomes. Additionally, the deformation of the block 400 may cause disengagement of block 400 from the mold, causing movement of the block 400 and corresponding undesirable changes in the shape of the final orthodontic device. In some cases, the deformation of the block may result in excessive engagement forces between the block 400 and the mold 410. Such excessive engagement forces may result in the block 400 being strongly retained on the mold 410. This excessive retention may result in damage to the orthodontic appliance during its removal from the mold.

Block 430 is depicted from a buccal or lingual view and depicts a block support structure 430 that is configured to be coupled to an aligner mold 440 via a coupling. The coupling may be a two-part coupling includes a block portion 432 and a mold portion 442. The block portion 432 may include an extension 436 that extends along the distal side of the block. A similar extension is shown extending from the mesial side of the block 430. The extensions 436 include an engagement portion 434, such as a hook or bead, that engages with a respective engagement portion 444 of the mold portion 440, which may be a recess. The mold portion may include an extension that extends upward, such as in an occlusal direction, from a base or platform of the mold. The platform 450 may be shaped to receive the block support structure 430 thereon. In some embodiments, the platform may have a shape that corresponds to the outline for outer perimeter of the lower surface of the block support structure 430. In some embodiments, the buccal extension 436 may comprise a plurality of extensions, each having a respective engagement portion 434. In some embodiments, the buccal extension may comprise a single extension that extends along the buccal side of the block 440 from the distal end to the mesial end of the block. The lingual extension may be similarly configured.

The mold portion 442 may include an engagement portion 444, which may be a receptacle, that engages with the engagement portion 434 of the block portion 432. In some embodiments, the engagement portion 444 and the engagement portion 434 may have complementary shapes such that the outer surface of the engagement portion 444 may match a shape of the outer surface of the engagement portion 434.

While the mold portion is depicted as being within the block portion, such that the extensions 436 are on the outer perimeter of the mold portion 440, in some embodiments, the mold portion may include extensions that are on the outer perimeter of the block portion.

In some embodiments, the mold portion 442 extends into a cavity 438 formed within the underside or tooth facing portion of the occlusal block 430 when the block 430 is mounted to the mold 440. In some embodiments, the block may include an extension that extends into a cavity of the mold portion 440, such that the respective engagement structures are switched as compared to what is shown in FIG. 4. The cavity may have one or more locating features that may interact with corresponding locating features on the mold. The cavity includes a sidewall that may be configured to come in contact with a sidewall of the extension of the mold portion. The cavity may also include an opposing sidewall that may be on an opposite side of the cavity that may be configured to come into contact with a corresponding sidewall of the extension. The respective sidewalls may be displaced from each other in a buccal-lingual orientation such that when the block support structure is placed on the mold, the respective sidewalls interact in order to align and constrain the movement of the occlusal block upon engagement with the engagement structure. Locating features may be formed along the mesial-distal or the buccal-lingual direction in order to locate and constrain the movement of the block support structure in the mesial-distal and/or buccal-lingual axis, respectively.

When coupled together, the upper surface 446 of the cavity 438 may be configured to contact the upper surface 448 of the extension of the mold 440. The surfaces may contact each other to provide support to the block 430 during the overmolding process, such as when a sheet of aligner material is thermoformed over the block 400 and the mold to aid in preventing deformation and movement of the block on the mold when subject to the overmolding forces, as discussed herein.

FIG. 5 depicts side and top views of a block 500 for use in fabricating and supporting an occlusal block of an aligner. The block 500 may include an interior cavity 510 that is surrounded by a sidewall 512. The shape of the interior surface of the sidewall 512 may include features that allow of indexing the block to a mold having a corresponding shape. For example, the block and mold may work in cooperation such that the block may be placed on the mold in a single orientation. For example, a first end of the cavity 512, such as a mesial or distal end of the cavity, may be defined by a curved sidewall surface 504 while a second end of the cavity, which may be the other of the mesial or distal end of the cavity, may be defined by a flat or planar sidewall. The mold may have corresponding sidewall shapes that match the shapes of the sidewalls of the blocks such that the curved shapes would interfere with the flat or planar sidewall of the mold if the block is inserted in the incorrect position, while being complementary to each other and allowing insertion when correctly oriented.

In some embodiments, the sidewalls may include one or more protrusions, such as protrusions 506. The protrusions may have a different shape, such as one being longer than the other or one being wider than the other. The mold may have corresponding sidewall shapes that match the shapes of the sidewalls of the blocks such that the extension length or width would interfere with the sidewall of the mold if the block is inserted in the incorrect position, while being complementary to each other and allowing insertion when correctly oriented.

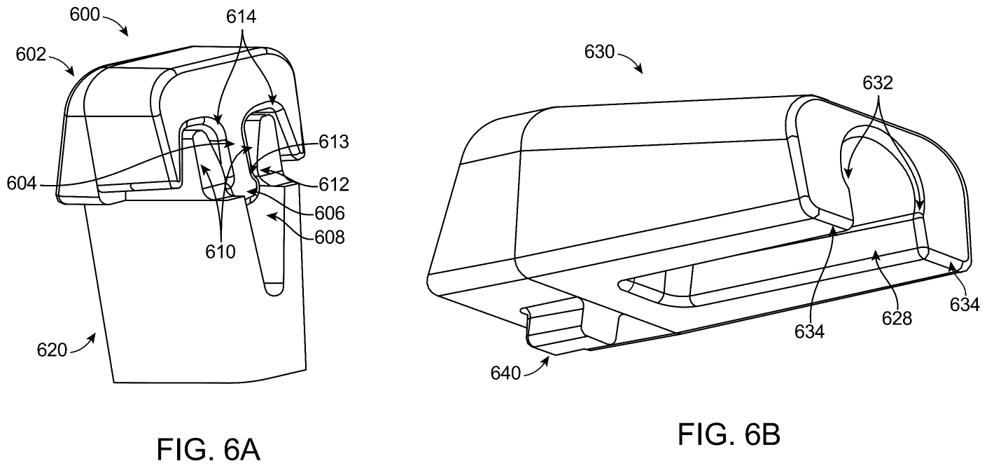

FIG. 6A depicts a system 600 that includes a 3D model of a block 602 and a 3D model of mold features 620 for receiving the block. The 3D model of the mold features 620 may be merged with a 3D model of the patient's dentition and/or a 3D model of the mold for an aligner to generate a finalized or composite 3D model that includes the mold features 620 for mounting an occlusal block along with the dentition or aligner features such as during the treatment planning process. For example, in a process for digitally planning an orthodontic treatment and/or design or fabrication of an appliance, as described herein.

The 3D model of the mold features 620 includes a well 608 and prongs 610. The prongs 610 are located on either side, such as buccally and lingually of the well 608 when the mold features 610 is integrated into the finalized mold model. The prongs extend in an occlusal direction and include tapered ends, that are narrow at the occlusal ends thereof and widen in the gingival direction to form protrusions 612 that extend into the well, before narrowing again where they meet the well 608. The prongs are flexible such that they may elastically deform outwards from the well as the ball head 608 is inserted between the prongs 610 and the ball head acts against the tapered ends of the prongs 610.

The occlusal block support structure 602 includes two receiving wells 614 shaped to receive the prongs 610. The shaft 604 extends in an occlusal-gingival direction between the two receiving wells 614. The shaft 604 has a ball head 606 on a distal end therefore. The shaft may have a dimension, such as a width as measured, for example, in a buccal-lingual direction (parallel to a buccal-lingual axis) that is narrower than the width of the ball head such that a recess may be formed along the shaft, between the ball head and the base of the shaft. The ball head 606 is shaped such that when inserted into the well, between the prongs, the ball head 606 pushes the prongs 610 away from each other until the ball head 606 is inserted beyond protrusions 612 formed on the prongs by the end of the tapered section. The prongs 610 may then deflect back towards each other, where the protrusions then engage with an upper surface 613 of the ball head and capture the ball head therebetween. The ball head is captured between the prongs because the resting distance between the protrusions 612 of the prongs 610 is less than the width of the ball head. The resting distance and the width of the ball head may be measured in a direction normal to the surfaces of the prongs and ball head, such as parallel to a buccal-lingual axis for FIG. 6A or a mesial distal axis for features rotated 90 degrees compared to what is depicted in FIG. 6A.

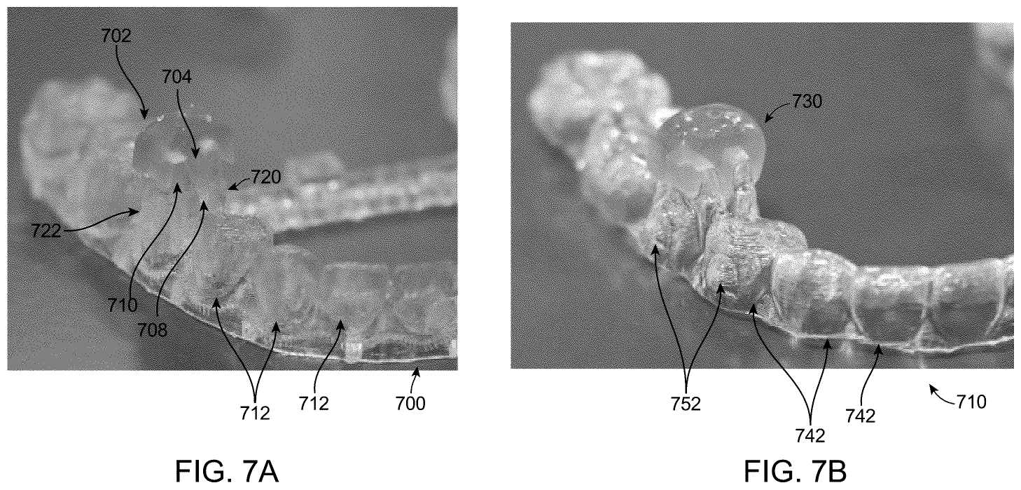

FIG. 7A depicts a mold 700 and a physical block support structure 702. The mold 700 was formed from a 3D model of an arch of tooth receiving cavities merged with a 3D model of the mold features 620. The resulting mold includes tooth receiving cavity features 712 along with physical mold features 720 from the 3D model of the mold features 620. The finalized mold 700 includes physical prongs 710 that corresponds to (e.g., has the same shape as) the shape of the model of the prongs 610, a physical well 708 that corresponds to the shape of the 3D model of the well 608, and the other features described with respect to the mold features 620. The mold also includes features 722 for forming attachment receiving cavities.

A physical block support structure 702 has been mounted on the prongs 710 with the shaft 704 engaged between the prongs 710. The block may be temporarily adhered to the mold with a temporary adhesive, such as food grade starch or other washable adhesives such as corn starch, wheat starch, potato starch, casein glue, cellulose gum, gum Arabic, and/or others.

FIG. 7B depicts an aligner 730 formed using the mold 700 with a block support structure 702 retained within a cavity of the aligner to form an occlusal block 730. The aligner also includes tooth receiving cavities 742 and attachment receiving cavities 752 formed by the respective features of the mold.

The block support structure may be welded to the aligner before removal of the aligner from the mold, as described herein.

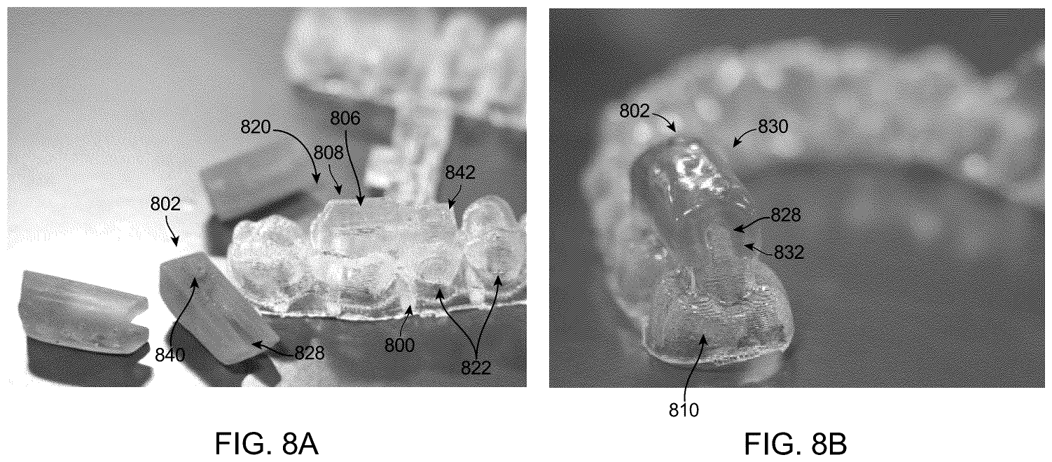

Returning to FIG. 6B, a 3D model of a block 602 is depicted. The block may be a support structure for an occlusal block of an orthodontic aligner. The 3D model of the block 630 includes a well 628 and protrusions 632. The protrusions 632 are located on either side, such as buccally and lingually of the well 628. The protrusions 632 extend in a gingival direction and include the protrusions at the distal or gingival end. The protrusions 632 narrow at the well at the opening thereof. The well widens in an occlusal direction. The sidewalls 634 of the block, from which the protrusions extend, are flexible such that they may elastically deform outwards from the well as a ball head (see ball head 808 of FIG. 8A) is inserted between the protrusions and into the well and the ball head acts against protrusions 632 and the side walls 634. The block 630 may include a locating feature 640 which may be a protrusion that extends from an underside of the block 630 and is received in a well 842 of the mold, see FIG. 8A.

FIG. 8A depicts a physical mold of an aligner 800 and a physical block support structure 802. The mold 800 was formed from a 3D model of an arch of tooth receiving cavities merged with a 3D model of mold features. The resulting mold includes tooth receiving cavity features along with physical mold features 820 from a 3D model of the mold features. The finalized mold 700 includes a physical shaft having a ball end 808 shaped to be inserted into the well 828 of the physical block support structure 802, a physical well 742 that is shaped to receive the locating feature 840, and the other features. The mold also includes features 822 for forming attachment receiving cavities.

A physical block support structure 802 may be mounted on the shaft 806 with the shaft 806 engaged within the well and between the protrusions 832. The block may be temporarily adhered to the mold with a temporary adhesive, such as food grade starch or other washable adhesives such as corn starch, wheat starch, potato starch, casein glue, cellulose gum, gum Arabic, and others.

FIG. 8B depicts an aligner formed using the mold 800 with the block support structure 802 retained within a cavity of the aligner to form an occlusal block 830.

The block support structure may be welded to the aligner before removal of the aligner from the mold, as described herein.

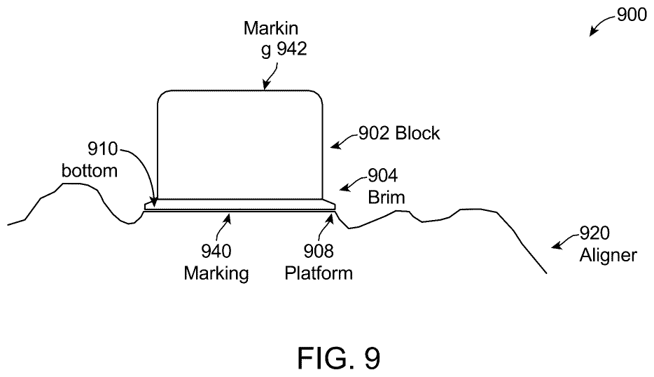

Aligners with blocks inserted within a cavity of an aligner or with an aligner formed over a block can result in high retentive forces between the aligner and the mold, as the thermoforming process may deform the blocks. Such high retention may result in extra handling during removal form the mold or breakage of the aligner during removal. FIG. 9 depicts an externally mounted occlusal block 902 mounted to a platform on an aligner 908. Welding a block onto an external surface of the aligner can obviate the retentive forces caused from thermoforming over block support structures. In some embodiments, the external welding can be performed while the aligner is still on the mold, such as after the thermoforming or overmolding process, which makes automation easier as features on the mold may be used for handling and alignment during the process. In some embodiments, aligners could be removed and mounted in a welding station similar. By welding blocks externally, it is possible that blocks could be modified after fabrication. For example, the upper or occlusal surface may undergo a material removal operation, such as sanding or shaving down, to be customized for patient fit and comfort.

The block 902 may be formed with a brim 904 that forms an outer perimeter of the block 902. The brim may extend around the entirety of the block 902. The block 902 may be placed on a platform 908 on an occlusal surface of the aligner 902 after the aligner is formed. The block may then be coupled to the aligner, such as through laser welding or other techniques. For example, the brim of the block may be laser welded to the platform.

Markings 940, 942 may also be added to the block and/or the aligner, such as during the laser welding process, the laser may be used to mark the aligner and/or block with a unique ID on the top of the block and/or on the underside of the platform or the underside of the block.

Laser welding of any of the blocks described herein to any of the aligners described herein may use an IR line laser to melt clearweld-coated blocks to the aligners. In some embodiments, a longer wavelength laser may be used to weld block to aligner material, even without clearweld. For example, a 2 micron laser may spot weld the block to the aligner. The laser may scan an area to be welded, combining multiple spot welds to form line welds or area welds. In some embodiments, the 2 micron laser may be focused through the aligner onto the surface of the block where the block contacts the aligner to weld the block to the aligner.

Spot welding may also be used to weld the blocks to the aligners. Spot welding allows an in-line pyrometer to be used for process monitoring and control. Additionally, clamping forces can be applied through the spot welder, such as through the use of a laser globo welder which utilizes a glass sphere to apply pressure to the workpiece and focus laser.

In some embodiments, the top or occlusal surface of the block support structures may be welded to the top or occlusal surface of the aligner. However, such processes may allow for gaps between the sides of the blocks and the aligner, where debris may collect during use. In some embodiments, blocks may be welded on a perimeter of a block base using spot laser technologies, which may seal the block to the aligner. In some embodiments, blocks may be welded on their buccal, lingual, mesial, and/or distal sides using a scanning spot laser or a rotating line laser to more securely seal the sides of the block to the aligner.

In some embodiments, ultrasonic welding may be used in addition to or instead of laser welding.

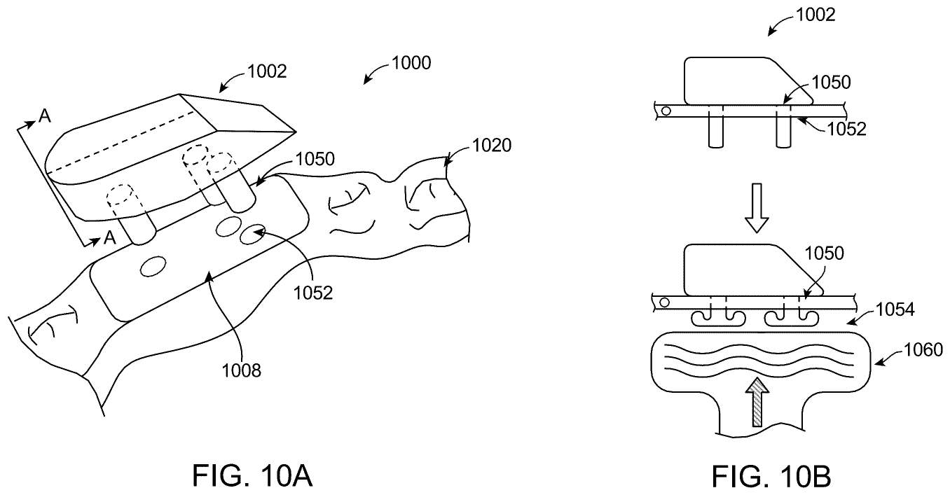

FIGS. 10A and 10B depict steps in a process of coupling a block 1002 to an aligner 1020. The block may include one or more extensions 1050 that extend from a base of the block. The aligner 1020 may include apertures 1052 through the aligner 1020. The apertures may be formed on a platform 1008 of the aligner. The platform may be shaped to mate with the bottom of the block 1002.

During fabrication the extensions 1050 are inserted though the apertures 1052 so that the bottom of the block 1050 rests on the platform 1008, as depicted at the top of FIG. 10B. Heat, such as through IR welding, ultrasonic welding, or through a heated tool 1060 may be applied to the extensions 1050. For example, heat may be applied from underneath the aligner and the block to deform the extension, such as to form a mushroom top or other structure that has a size greater than the diameter of the apertures 1052, to thus retain the block on the aligner.

Use of prefabricated blocks may limit the types of blocks that may be used, because the fabrication process may place constraints on the block shapes. But thermoformed aligners without support blocks are weak and susceptible to crushing and other forms of plastic deformation that may make them unusable.

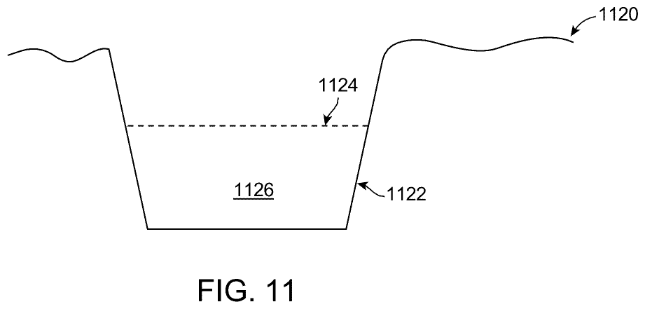

In some embodiments, thermoformed aligners, such as the aligner 1120 of FIG. 11 may be formed to be customized to the patient. The cavity 1122 of the aligner may be filled after fabrication, for example, with a liquid that solidifies. The overall shape of the occlusal block may be created by thermoforming, but rather than inserting a prefabricated block, liquid material may be to fill in the block cavity 1122. In some embodiments, the volume of the liquid may be determined based on the 3D model of the block and then the volume may be provided to a fabricator or dispending machine for dispending into the block cavity such as during the treatment planning process. For example, in a process for digitally planning an orthodontic treatment and/or design or fabrication of an appliance, as described herein. In some embodiments, the block cavity may have an indicator 1124, such as a fill line, formed thereon to indicate the fill level of the material 1126 for reinforcing the block. Material may include EP40 potting material, UV curable resin, or other epoxies. The advantage this approach has over previous methods is that block shapes can be customized to patient fit and comfort as prefabricated blocks are not used.

In some embodiments, the block support structures may be directly fabricated, such as through 3D printing or additive manufacturing. A 3D printed block may be inserted into thermoformed aligners. In some embodiments, a 3D printed block may be fabricated in situ, such as directly within a block cavity 1122 of the aligner 1120. An advantage of such a method is that the 3D printed material may be heated to a point where it bonds directly with the aligner material during formation of the block, such as through an FDM fabrication process. An elongated nozzle mounted to a robotic arm having greater than three degrees of freedom, such as three translational degrees of freedom and at least one or two rotational degree of freedom, may be used to fabricate the block. In some embodiments, the nozzle may be controlled with six degrees of freedom. In some embodiments, the nozzle may be stationary while the aligner is moved in the degrees of freedom to fabricate the block.

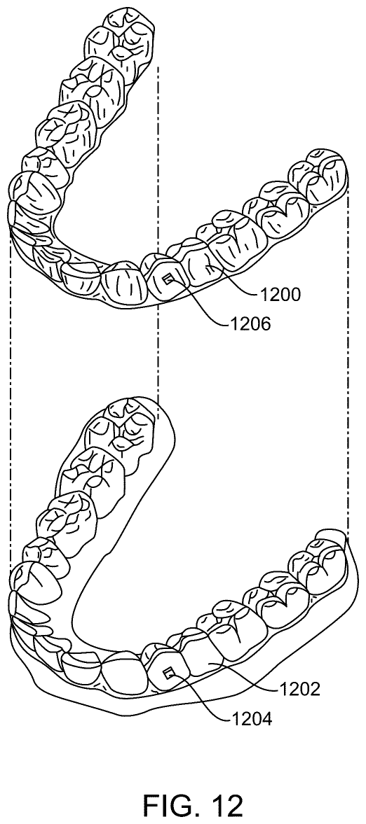

FIG. 12 depicts an orthodontic aligner and patient's dental arch, in accordance with some embodiments;

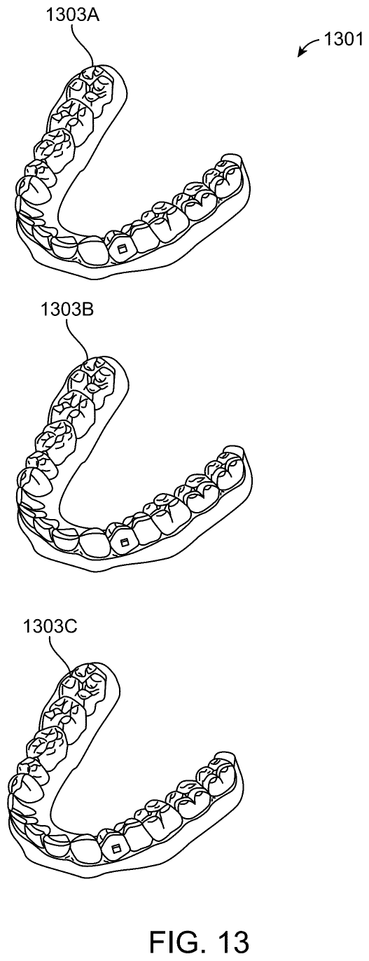

FIG. 13 depicts a system of orthodontic aligners, in accordance with some embodiments;

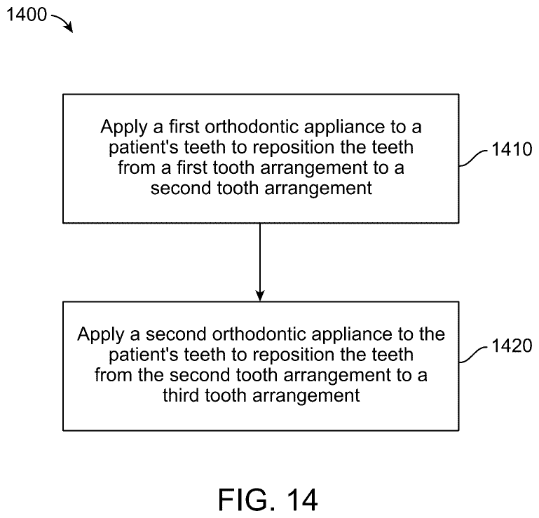

FIG. 14 shows a method of orthodontic treatment, in accordance with some embodiments;

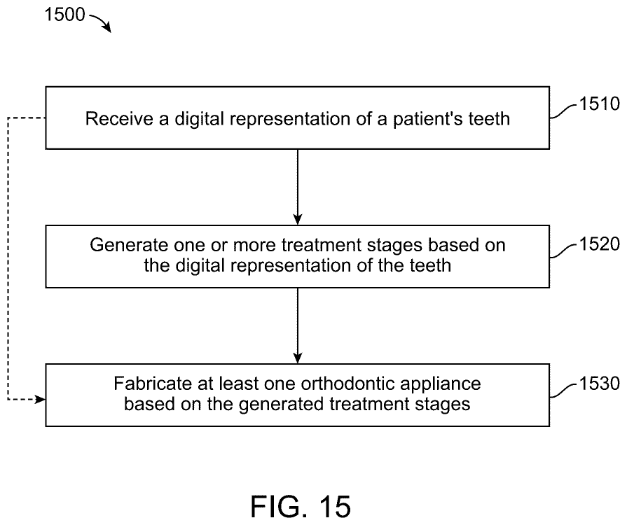

FIG. 15 shows a method of treatment planning, in accordance with some embodiments;

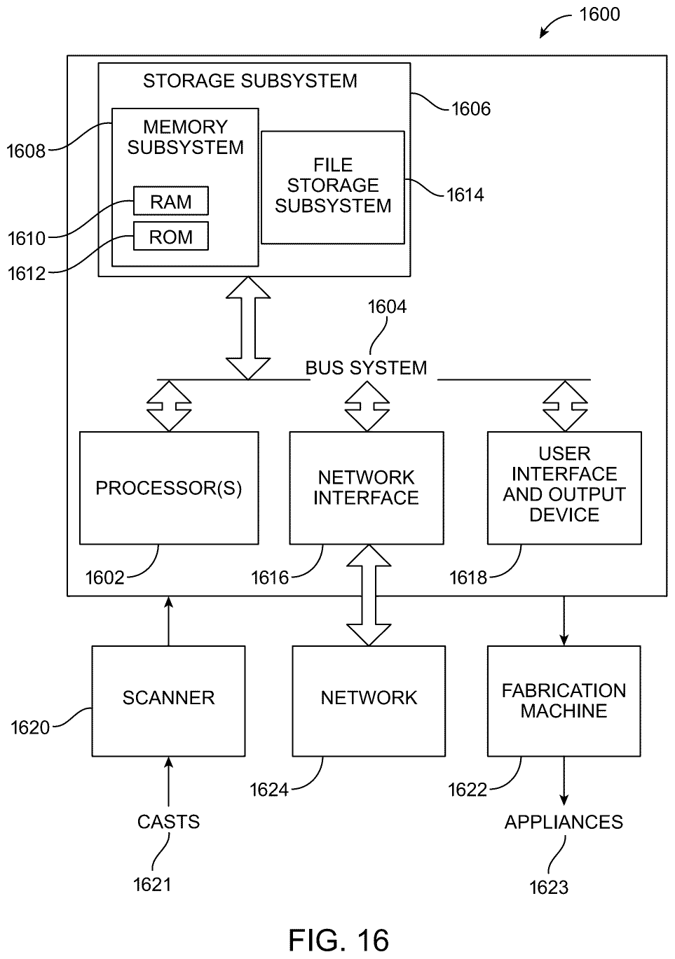

FIG. 16 shows a system for use in dental treatment, in accordance with some embodiments; and

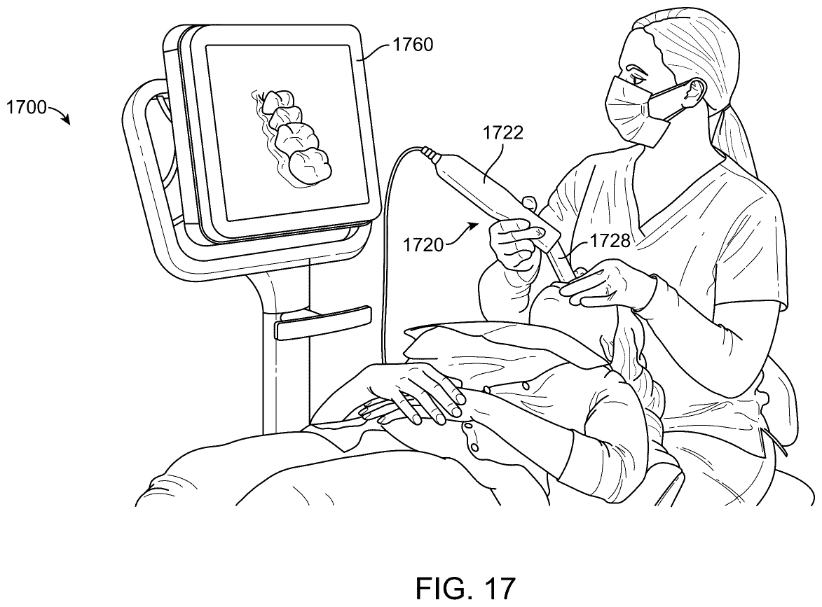

FIG. 17 shows an intraoral scanning system, in accordance with some embodiments.

FIG. 12 illustrates an exemplary tooth repositioning appliance 1200, such as an aligner that can be worn by a patient in order to achieve an incremental repositioning of individual teeth 1202 in the jaw. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. The physical model (e.g., physical mold) of teeth can be formed through a variety of techniques, including 3D printing. The appliance can be formed by thermoforming the appliance over the physical model. In some embodiments, a physical appliance is directly fabricated, e.g., using additive manufacturing techniques, from a digital model of an appliance. In some embodiments, the physical appliance may be created through a variety of direct formation techniques, such as 3D printing. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some or most, and even all, of the teeth will be repositioned at some point during treatment. Teeth that are moved can also serve as a base or anchor for holding the appliance as it is worn by the patient. In some embodiments, no wires or other means will be provided for holding an appliance in place over the teeth. In some cases, however, it may be desirable or necessary to provide individual attachments or other anchoring elements 1204 on teeth 1202 with corresponding receptacles or apertures 1206 in the appliance 1200 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, the disclosure of which are herein incorporated by reference in their entirety, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450, the disclosure of which are herein incorporated by reference in their entirety.

FIG. 13 illustrates a tooth repositioning system 1301 including a plurality of appliances 1303A, 1303B, 1303C. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1301 can include a first appliance 1303A corresponding to an initial tooth arrangement, one or more intermediate appliances 1303B corresponding to one or more intermediate arrangements, and a final appliance 1303C corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

Optionally, in cases involving more complex movements or treatment plans, it may be beneficial to utilize auxiliary components (e.g., features, accessories, structures, devices, components, and the like) in conjunction with an orthodontic appliance. Examples of such accessories include but are not limited to elastics, wires, springs, bars, arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like. In some embodiments, the appliances, systems and methods described herein include improved orthodontic appliances with integrally formed features that are shaped to couple to such auxiliary components, or that replace such auxiliary components.

FIG. 14 illustrates a method 1400 of orthodontic treatment using a plurality of appliances, in accordance with many embodiments. The method 1400 can be practiced using any of the appliances or appliance sets described herein. In step 1410, a first orthodontic appliance is applied to a patient's teeth in order to reposition the teeth from a first tooth arrangement to a second tooth arrangement. In step 1420, a second orthodontic appliance is applied to the patient's teeth in order to reposition the teeth from the second tooth arrangement to a third tooth arrangement. The method 1400 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 15 illustrates a method 1500 for digitally planning an orthodontic treatment and/or design or fabrication of an appliance, in accordance with many embodiments. The method 1500 can be applied to any of the treatment procedures described herein and can be performed by any suitable data processing system. Any embodiment of the appliances described herein can be designed or fabricated using the method 1500.

In step 1510, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

The digital representation may include a digital model of the patient's upper or lower jaw.

In step 1520, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In step 1530, at least one orthodontic appliance is fabricated based on the generated treatment stages. For example, a set of appliances can be fabricated to be sequentially worn by the patient to incrementally reposition the teeth from the initial arrangement to the target arrangement. Some of the appliances can be shaped to accommodate a tooth arrangement specified by one of the treatment stages. Alternatively or in combination, some of the appliances can be shaped to accommodate a tooth arrangement that is different from the target arrangement for the corresponding treatment stage. For example, as previously described herein, an appliance may have a geometry corresponding to an overcorrected tooth arrangement. Such an appliance may be used to ensure that a suitable amount of force is expressed on the teeth as they approach or attain their desired target positions for the treatment stage. As another example, an appliance can be designed in order to apply a specified force system on the teeth and may not have a geometry corresponding to any current or planned arrangement of the patient's teeth.

In some instances, staging of various arrangements or treatment stages may not be necessary for design and/or fabrication of an appliance. As illustrated by the dashed line in FIG. 15, design and/or fabrication of an orthodontic appliance, and perhaps a particular orthodontic treatment, may include use of a representation of the patient's teeth (e.g., receive a digital representation of the patient's teeth 1510), followed by design and/or fabrication of an orthodontic appliance based on a representation of the patient's teeth in the arrangement represented by the received representation.

FIG. 16 is a simplified block diagram of a data processing system 1600 that may be used in executing methods and processes described herein. The data processing system 1600 typically includes at least one processor 1602 that communicates with one or more peripheral devices via bus subsystem 1604. These peripheral devices typically include a storage subsystem 1606 (memory subsystem 1608 and file storage subsystem 1614), a set of user interface input and output devices 1618, and an interface to outside networks 1616. This interface is shown schematically as “Network Interface” block 1616, and is coupled to corresponding interface devices in other data processing systems via communication network interface 1624. Data processing system 1600 can include, for example, one or more computers, such as a personal computer, workstation, mainframe, laptop, and the like.

The user interface input devices 1618 are not limited to any particular device, and can typically include, for example, a keyboard, pointing device, mouse, scanner, interactive displays, touchpad, joysticks, etc. Similarly, various user interface output devices can be employed in a system of the invention, and can include, for example, one or more of a printer, display (e.g., visual, non-visual) system/subsystem, controller, projection device, audio output, and the like.

Storage subsystem 1606 maintains the basic required programming, including computer readable media having instructions (e.g., operating instructions, etc.), and data constructs. The program modules discussed herein are typically stored in storage subsystem 1606. Storage subsystem 1606 typically includes memory subsystem 1608 and file storage subsystem 1614. Memory subsystem 1608 typically includes a number of memories (e.g., RAM 1610, ROM 1612, etc.) including computer readable memory for storage of fixed instructions, instructions and data during program execution, basic input/output system, etc. File storage subsystem 1614 provides persistent (non-volatile) storage for program and data files, and can include one or more removable or fixed drives or media, hard disk, floppy disk, CD-ROM, DVD, optical drives, and the like. One or more of the storage systems, drives, etc. may be located at a remote location, such coupled via a server on a network or via the internet/World Wide Web. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

Scanner 1620 includes any means for obtaining a digital representation (e.g., images, surface topography data, etc.) of a patient's teeth (e.g., by scanning physical models of the teeth such as casts 1621, by scanning impressions taken of the teeth, or by directly scanning the intraoral cavity), which can be obtained either from the patient or from treating professional, such as an orthodontist, and includes means of providing the digital representation to data processing system 1600 for further processing. Scanner 1620 may be located at a location remote with respect to other components of the system and can communicate image data and/or information to data processing system 1600, for example, via a network interface 1624. Fabrication system 1622 fabricates appliances 1623 based on a treatment plan, including data set information received from data processing system 1600. Fabrication machine 1622 can, for example, be located at a remote location and receive data set information from data processing system 1600 via network interface 1624.

Reference is now made to FIG. 17, which illustrates an intraoral scanning system 1700, in accordance with some embodiments of the present invention. The intraoral scanning system 1700 comprises an elongate handheld wand 1722 that has a probe 1728 at distal end of the handheld wand 1722. Probe 1728 has a distal end and a proximal end. As used herein, the proximal end of the handheld wand is the end of the handheld wand that is closest to a user's hand when the user is holding the handheld wand in a ready-for-use position and the distal end of the handheld wand is the end of the handheld wand that is farthest from the user's hand when the user is holding the handheld wand in a ready-for-use position. The intraoral scanning system and/or the handheld wand may include some of all of the features and capabilities of the processing system 1700, depicted in and described with reference to FIG. 16. The intraoral scanning system and/or the handheld wand may be used to carry out the processes shown and described herein.

In some embodiments, an intraoral scanner may include an intraoral imaging system, such as a structured light projector disposed in proximal end of probe along with one or more light field cameras also disposed in proximal end of probe 1728. Although an embodiment of the intraoral 3D scanner may be include a structured light scanner. The system 1700 may use a 3D scanning probe using one or more of many different types of 3D scanning hardware and software. For example, the 3D scanning system may be a confocal 3D scanning system, a photogrammetry scanner, or other 3D scanning system type.

The intraoral scanner may include a camera and light sensor that comprises an image sensor comprising an array of pixels, e.g., a CMOS image sensor, or multiple cameras and/or sensors.

Intraoral scanning system 1700 may include control circuitry that controls the scanning process, such the projection of light, such as a structured light pattern, onto intraoral tissue, such as teeth and gingiva, and the capture of light reflecting intraoral tissue. Using information from intraoral scanner, a computer processor may reconstruct a three-dimensional image of the surface of the intraoral tissue, such as the dentition discussed herein and may output the image to an output device 1760, e.g., a monitor. It is noted that computer processor, such as the processors 1702 of FIG. 16 is depicted by way of illustration and not limitation, and may be located outside of handheld wand 1722. In some embodiments, computer processors may be disposed within handheld wand 1722.

The intraoral scanning system may generate point clouds representing the three-dimensional surface of the intraoral tissue. The intraoral scanning system may generate up to 60 frames per second of point cloud data that may be used to generate a three-dimensional model of the surface of the intraoral tissue.

In some embodiments, the scanning system may also capture the color of the surfaces of the intraoral tissue. For example, in some embodiments the scanning system may include a light source in or on the wand 1722. The light source may be a white light source and the camera may record the color of the surface of the intraoral tissue based on the light reflected from the object.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination.

As used herein, characters such as numerals refer to like elements.

The present disclosure includes the following numbered clauses.

Clause 1. An orthodontic appliance comprising: a polymeric shell; a plurality of tooth receiving cavities formed in the polymeric shell that are shaped to move teeth of a patient from a first arrangement towards a second arrangement; an occlusal block extending from an occlusal surface of the polymeric shell; a cavity formed within the occlusal block; and a modular block support structure located within the cavity, wherein the modular block support structure comprises a base module coupled to one or more additional modules.

Clause 2. The orthodontic appliance of clause 1, wherein the additional modules are coupled to a mesial or distal end of the base module.

Clause 3. The orthodontic appliance of clause 1, wherein the additional modules are coupled to an occlusal surface of the base module.

Clause 4. The orthodontic appliance of clause 1, wherein the additional modules are coupled to a mesial or distal end and an occlusal surface of the base module.

Clause 5. The orthodontic appliance of clause 1, further comprising a coupling that couples the base module to at least one of the additional modules.

Clause 6. The orthodontic appliance of clause 5, wherein the coupling interlocks the based module and the additional modules together.

Clause 7. The orthodontic appliance of clause 5, wherein the coupling includes an extension on the additional module and a receptacle in the base module for receiving the extension.

Clause 8. A method of fabricating an orthodontic aligner comprising: forming a mold for an orthodontic aligner, the mold comprising tooth receiving cavities shaped to move teeth of a patient form a first orientation towards a second orientation and a receptacle shaped to receive a base of a mold for an occlusal block; inserting a mold for an occlusal block into the receptacle, the mold for the occlusal block including a base for insertion into the receptable and a block support structure coupled to the base; overmolding a sheet of aligner material over the mold for the orthodontic aligner and the mold for the occlusal block; removing the sheet of aligner material from the mold for the orthodontic aligner while retaining the block support structure in the orthodontic aligner.

Clause 9. The method of clause 8, wherein removing the sheet of aligner material from the mold for the orthodontic aligner while retaining the block support structure in the orthodontic aligner includes separating the block support structure form the base.

Clause 10. The method of clause 9, wherein the block support structure is coupled to the base with one or more breakaway connections.

Clause 11. The method of clause 10, wherein separating the block support structure form the base includes breaking the one or more breakaway connections.

Clause 12. The method of clause 8, further comprising: forming the mold for an occlusal block.

Clause 13. The method of clause 8, wherein the mold for the occlusal block is injection molded.

Clause 14. The method of clause 8, wherein forming the mold for the orthodontic aligner includes directly fabricating the mold for the orthodontic aligner.

Clause 15. The method of clause 8, wherein the receptable is a well located between two tabs that that extend in an occlusal direction.

Clause 16. A method of fabricating an orthodontic aligner comprising: forming a mold for an orthodontic aligner, the mold comprising tooth receiving cavities shaped to move teeth of a patient form a first orientation towards a second orientation and a receptacle shaped to receive a base of a mold for an occlusal block; coupling an occlusal block support structure to the mold; overmolding a sheet of aligner material over the mold for the orthodontic aligner and the mold for the occlusal block; and removing the sheet of aligner material from the mold for the orthodontic aligner while retaining the occlusal block support structure in the orthodontic aligner.

Clause 17. The method of clause 16, wherein the mold for the orthodontic aligner includes a well for receiving at portion of the occlusal block support structure.

Clause 18. The method of clause 17, wherein the occlusal block support structure includes an extension that is inserted into the well.

Clause 19. The method of clause 18, wherein extension includes a ball head that is retained within the well during the overmolding.

Clause 20. The method of clause 19, wherein the mold for the orthodontic aligner includes a pair of prongs on either side of the well, the prongs engaging with the ball head to retain the occlusal block support structure.

Clause 21. An orthodontic appliance comprising: a polymeric shell; a plurality of tooth receiving cavities formed in the polymeric shell that are shaped to move teeth of a patient from a first arrangement towards a second arrangement; an occlusal surface of the polymeric shell including a platform shaped to receive an occlusal block; and an occlusal block coupled to the platform and extending from an occlusal surface of the polymeric shell; a cavity formed within the occlusal block; and a modular block support structure located within the cavity, wherein the modular block support structure comprises a base module coupled to one or more additional modules.

Clause 22. The orthodontic appliance of clause 21, wherein the occlusal block is solid.

Clause 23. The orthodontic appliance of clause 21, wherein the occlusal block is laser welded to the platform.

Clause 24. The orthodontic appliance of clause 23, further comprising a brim at an outer perimeter of the occlusal block.

Clause 25. The orthodontic appliance of clause 24, wherein the occlusal block is laser welded to the platform at the brim.

Clause 26. A method of fabricating an orthodontic aligner comprising: forming a mold for an orthodontic aligner, the mold comprising tooth receiving cavities shaped to move teeth of a patient form a first orientation towards a second orientation and a mold for an occlusal block; overmolding a sheet of aligner material over the mold for the orthodontic aligner and the mold for the occlusal block; removing the sheet of aligner material from the mold for the orthodontic aligner and the mold for the occlusal block to form an aligner having tooth receiving cavities and an occlusal block having a cavity; and filling the cavity of the occlusal block with curable material.

Clause 27. The method of clause 26, further comprising: determining a location of a fill line for filing the cavity of the occlusal block.

Clause 28. The method of clause 27, wherein the mold of the occlusal block includes a fill line structure for forming a fill line in the sheet of aligner material.

Clause 29. The method of clause 27, wherein the fill line is configured to be located occlusal of an occlusal surface of the teeth of the patient when the orthodontic aligner is worn by the patient.

Clause 30. The method of clause 27, wherein filling the cavity of the occlusal block includes filling the cavity to the fill line.

Clause 31. The method of clause 26, further comprising: determining a volume of curable material to fill the cavity of the occlusal block.

Clause 32. A system for orthodontic treatment, the system comprising: a processor; and memory comprising instructions that when executed by the processor cause the system to carry out a method including: receiving one or more three-dimensional (3D) digital models of a patient's dentition; generating a treatment plan that move the patient's dentition from a first arrangement towards a second arrangement while repositioning a mandible; generating a 3D model of an orthodontic aligner configured to reposition the mandible, the orthodontic aligner including of any one of clauses 1-7 and 21-25.

Clause 33. A system for orthodontic treatment, the system comprising: a processor; and memory comprising instructions that when executed by the processor cause the system to carry out a method including: receiving one or more three-dimensional (3D) digital models of a patient's dentition; generating a treatment plan that move the patient's dentition from a first arrangement towards a second arrangement while repositioning a mandible; generating a 3D model of an orthodontic aligner configured to reposition the mandible, wherein the orthodontic aligner comprises: a polymeric shell, a plurality of tooth receiving cavities formed in the polymeric shell that are shaped to move teeth of a patient from a first arrangement towards a second arrangement, an occlusal block extending from an occlusal surface of the polymeric shell, a cavity formed within the occlusal block, and an occlusal block support structure configured to be located within the cavity; and fabricating the orthodontic aligner having one or more occlusal blocks based on the 3D model of an orthodontic aligner.

Clause 34. The system of clause 33, wherein the method further comprises: determining, based on the one or more 3D models, that a mandible of the patient is to be repositioned.

Clause 35. The system of clause 33, wherein the method further comprises:
merging a 3D model of a dental appliance mold generated base done on the 3D model of the orthodontic aligner with a model of a 3D model of mold features for mounting an occlusal block to generate an updated dental appliance mold.

Clause 36. The system of clause 35, wherein the mold features for mounting an occlusal block include a well disposed between two prongs.

Clause 37. The system of clause 35, wherein the mold features for mounting an occlusal block include a platform configured to receive an occlusal block support.

Clause 38. The system of clause 35, wherein the mold features for mounting an occlusal block include an aperture shaped to receive an extension that extends from an occlusal block.

Clause 39. The system of clause 35, wherein the mold features for mounting an occlusal block include a ball head shaped to engage with an occlusal block.

Clause 40. The method of clause 39, wherein the mold features for mounting an occlusal block include a ball head shaped to engage with an occlusal block

Clause 41. The system of clause 33, wherein the occlusal block support structure comprises a base module coupled to one or more additional modules.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A method of fabricating an orthodontic aligner comprising:
forming a mold for an orthodontic aligner, the mold comprising tooth receiving cavities shaped to move teeth of a patient form a first orientation towards a second orientation and a receptacle shaped to receive a base of a mold for an occlusal block;
inserting a mold for an occlusal block into the receptacle, the mold for the occlusal block including a base for insertion into the receptable and a block support structure coupled to the base;
over molding a sheet of aligner material over the mold for the orthodontic aligner and the mold for the occlusal block;
removing the sheet of aligner material from the mold for the orthodontic aligner while retaining the block support structure in the orthodontic aligner.

2. The method of claim 1, wherein removing the sheet of aligner material from the mold for the orthodontic aligner while retaining the block support structure in the orthodontic aligner includes separating the block support structure form the base.

3. The method of claim 2, wherein the block support structure is coupled to the base with one or more breakaway connections.

4. The method of claim 3, wherein separating the block support structure form the base includes breaking the one or more breakaway connections.

5. The method of claim 1, further comprising:
forming the mold for an occlusal block.

6. The method of claim 1, wherein the mold for the occlusal block is injection molded.

7. The method of claim 1, wherein forming the mold for the orthodontic aligner includes directly fabricating the mold for the orthodontic aligner.

8. The method of claim 1, wherein the receptable is a well located between two tabs that that extend in an occlusal direction.

9. The method of claim 1, wherein over molding includes thermoforming.

10. A method of fabricating an orthodontic aligner comprising:
forming a mold for an orthodontic aligner, the mold comprising tooth receiving cavities shaped to move teeth of a patient form a first orientation towards a second orientation and a receptacle shaped to receive a base of a mold for an occlusal block;
coupling an occlusal block support structure to the mold;
overmolding a sheet of aligner material over the mold for the orthodontic aligner and the mold for the occlusal block; and
removing the sheet of aligner material from the mold for the orthodontic aligner while retaining the occlusal block support structure in the orthodontic aligner.

11. The method of claim 10, wherein the mold for the orthodontic aligner includes a well for receiving at portion of the occlusal block support structure.

12. The method of claim 11, wherein the occlusal block support structure includes an extension that is inserted into the well.

13. The method of claim 12, wherein extension includes a ball head that is retained within the well during the overmolding.

14. The method of claim 13, wherein the mold for the orthodontic aligner includes a pair of prongs on either side of the well, the prongs engaging with the ball head to retain the occlusal block support structure.

15. A method of fabricating an orthodontic aligner comprising:
forming a mold for an orthodontic aligner, the mold comprising tooth receiving cavities shaped to move teeth of a patient form a first orientation towards a second orientation and a mold for an occlusal block;
overmolding a sheet of aligner material over the mold for the orthodontic aligner and the mold for the occlusal block;
removing the sheet of aligner material from the mold for the orthodontic aligner and the mold for the occlusal block to form an aligner having tooth receiving cavities and an occlusal block having a cavity; and
filling the cavity of the occlusal block with curable material.

16. The method of claim 15, further comprising:
determining a location of a fill line for filing the cavity of the occlusal block.

17. The method of claim 16, wherein the mold of the occlusal block includes a fill line structure for forming a fill line in the sheet of aligner material.

18. The method of claim 16, wherein the fill line is configured to be located occlusal of an occlusal surface of the teeth of the patient when the orthodontic aligner is worn by the patient.

19. The method of claim 16, wherein filling the cavity of the occlusal block includes filling the cavity to the fill line.

20. The method of claim 15, further comprising:
determining a volume of curable material to fill the cavity of the occlusal block.
